(19) United States
(12) Patent Application Publication
(10) Pub. No.: US 2017/0151744 A9
(43) Pub. Date: Jun. 1, 2017

(54) PROCESS AND APPARATUS FOR PRODUCING STABLE HONEYCOMB STRUCTURES OF ANY DESIRED FORM FROM CORRUGATED PAPER

(71) Applicant: Alfred ISELI, (US)

(72) Inventor: Alfred ISELI, Uttwil (CH)

(21) Appl. No.: 14/773,792

(22) PCT Filed: Mar. 13, 2014
(86) PCT No.: PCT/IB2014/000332

§ 371 Date: Sep. 9, 2015

Related U.S. Application Data
(60) Provisional application No. 61/778,519, filed on Mar. 13, 2013.
(60) Provisional application No. 61/833,959, filed on Jun. 12, 2013.

(51) Int. Cl. B31D 3/00

(52) U.S. Cl. CPC B31D 3/007

(57) ABSTRACT

An apparatus for the fabrication of mechanically stable, planar rectangular or quadratic plates or bent plates from comigated cardboard at an industrial scale with minimum waste and dust. generation.

### CROSS REFERENCE TO RELATED APPLICATIONS

This application claim the benefit of U.S. Provisional Application No. 61/778,519, filed Mar. 13, 2013 and U.S. Provisional Application No. 61/833,959, filed Jun. 6, 12/2013, the contents of which are incorporated herein by reference.

### COPYRIGHT & LEGAL NOTICE

A portion of the disclosure of this patent document contains material which is subject to copyright protection. The Applicant has no objection to the facsimile reproduction by anyone of the patent document or the patent disclosure as it appears in the Patent and Trademark Office patent file or records, but otherwise reserves all copyright rights whatsoever. Further, no references to third party patents or articles made herein is to be construed as an admission that the present invention is not entitled to antedate such material by virtue of prior invention.

### FIELD OF THE INVENTION

The invention relates to an apparatus and process for the industrial fabrication of ultra-light cardboard structures with a mechanical stability sufficient for house construction.

### BACKGROUND OF THE INVENTION

Stacks comprising corrugated cardboard layers glued to flat substrate foils make up the cores of plates with excellent mechanical stability, when being cut in such a way that corrugations are oriented perpendicular to the plane of the plates. Such plates have for example been used to manufacture cardboard pallets of norm size which are mechanically stable while weighing far less than pallets made from solid wood (see for example International patent application no. WO93/16927 to Iseli, the entire disclosure of which is hereby incorporated by reference).

The extraordinary mechanical stability of suitable cardboard structures made from stacks of corrugated cardboard layers has even permitted their use in building construction, when combining the paper base with appropriate coatings to make the structures fireproof and waterproof (see for example German patent application no. DE196 54 672 to Iseli, the entire disclosure of which is hereby incorporated by reference).

One way of producing the cardboard plates is to cut endless webs of one-sided corrugated cardboard sheets from a cardboard production machine into rectangular sheets. Subsequently, these sheets are glued for example into 1.20 to 1.50 m high stacks of sheets, each one with the same direction of the corrugation. After a certain drying time the cardboard plates are then obtained by cutting the stacks perpendicular to the corrugation direction, for example by a wire saw or band saw. This process may not only produce a lot of waste by as much as 20% and large amounts of dust, but often also faulty plates, because of poor control of the uniformity of the glue within the stacks. In addition, after sawing the cardboard plates need to be calibrated by grinding.

Much more uniform gluing and negligible waste and dust has been shown to arise in a roll-to-roll process, wherein gluing and cutting by razor blades are carried out right before the web of one-sided corrugated cardboard sheets is spun onto a hollow drum (see for example German patent application no. DE103 05 747 to Iseli, the entire disclosure of which is hereby incorporated by reference). This process makes subsequent grinding superfluous. It is a further advantage of this process that the cardboard plates no longer need to be calibrated, since cutting by razor blades can be achieved with a precision of 0.1 mm. Furthermore, upon employing razor blades for cutting, the waves of the corrugated cardboard are no longer squeezed during processing, as often happens when crush cut knives are being used. Squeezing of the waves by excessive mechanical pressure during cutting is highly undesirable since pressing the waves onto the substrate foil may result in practically closed honeycombs.

PCT/IB2012/002173 teaches the integration of the apparatus for gluing and cutting described in DE103 05 747 into an industrial tool for the production of corrugated cardboard. This tool is suitable for the fabrication of honeycomb rolls with a length of 1.25 to 2.50 m at a typical speed of the cardboard web of 150-400 m/min. Its final product consists either of round or hexagonal plates (honeycombs) with a central hole. It is not possible to fabricate rectangular plates with the tool described in PCT/1B2012/002173.

What is needed is a process and apparatus for the industrial manufacturing of light-weight cardboard structures (honeycombs) of exceptional mechanical strength with and diverse shapes. Still further, what is needed is such a process that reduces waste and dust production.

### SUMMARY OF THE INVENTION

The purpose of this invention is to transfer the production worthiness for round plates or honeycomb wheels proven in PCT/IB2012/002173 to rectangular or quadratic plates. A simple modification of the process permits even honeycombs of more complicated, three-dimensional shape to be fabricated. Similar to PCT/IB2012/002173 the apparatus of the invention produces hardly any waste, and the new technology reduces the number of working steps at least by one. The apparatus of the invention comprises a transporter, a first cutting station, a stacker, a conveyer, a gluing station, a second cutting station, a positioning device, and a pressing station. A method for fabricating the corrugated cardboard structures is also provided.

### BRIEF DESCRIPTION OF THE DRAWINGS

FIG. 1 is a longitudinal cross-section through an apparatus for the fabrication of rectangular plates (honeycombs) made from corrugated cardboard with stations for gluing and cutting.

FIG. 2 is a plan-view of the gluing station and cardboard stack for the fabrication of three-dimensional honeycomb structures.

FIG. 3A is a side view of a cutting unit with razor blades.

FIG. 3B is a front view of a cutting unit with razor blades.

FIG. 4 is a partial view of a cutting unit.

FIG. 5A is a side view of an apparatus for the fabrication of rectangular plates (honeycombs) made from corrugated cardboard with a stationary station for cutting with circular blades and a station for gluing.

FIG. 5B is another apparatus for the fabrication of rectangular plates (honeycombs) made from corrugated cardboard with a gluing station and a movable station for cutting with circular blades.

Those skilled in the art will appreciate that elements in the Figures are illustrated for simplicity and clarity and have not necessarily been drawn to scale. For example, dimensions may be exaggerated relative to other elements to help improve understanding of the invention and its embodiments. Furthermore, when the terms ‘first’, ‘second’, and the like are used herein, their use is intended for distinguishing between similar elements and not necessarily for describing a sequential or chronological order. Moreover, relative terms like ‘front’, back', ‘top’ and ‘bottom’, and the like in the Description and/or in the claims are not necessarily used for describing exclusive relative position. Those skilled in the art will therefore understand that such terms may be interchangeable with other terms, and that the embodiments described herein are capable of operating in other orientations than those explicitly illustrated or otherwise described.

### DETAILED DESCRIPTION OF THE PREFERRED EMBODIMENTS

The following description is in no way to limit the scope of the invention. It is of an exemplary nature and designed to describe the best principle of action of the invention as it is known to the inventor at the time of filing of this document.

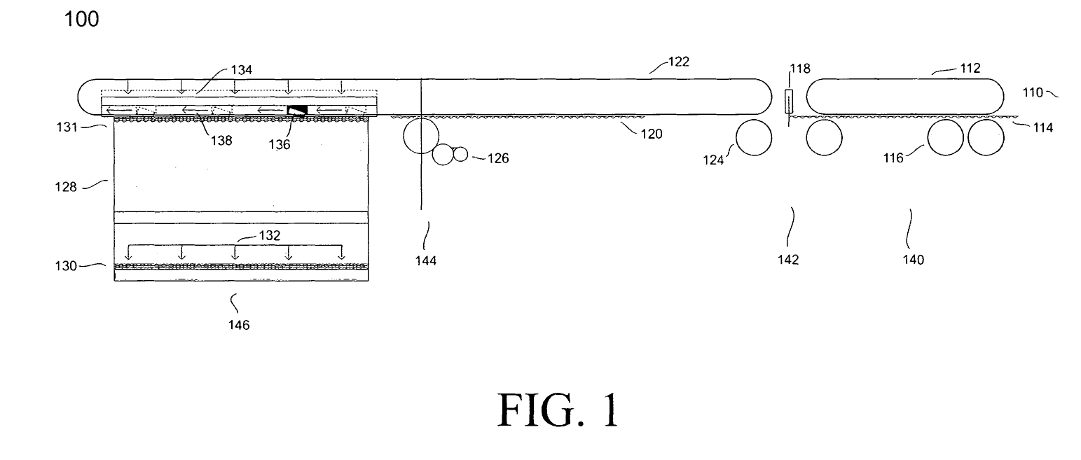

According to the longitudinal cross-section of FIG. 1 apparatus 100 for the fabrication of rectangular or quadratic plates (honeycombs) made from corrugated cardboard is described. In the apparatus 100 a web of single wave cardboard 114 coming from a cardboard production machine or from a roll-off device 110 is attracted through the substrate foil by a vacuum-belt 112 at a first station 140. The cardboard web is then transported step-wise from station 140 to cutting station 142, where, while remaining stationary, it is cut into sheets 120 by knife 118 perpendicular to the transport direction of the web, i.e. parallel to the crests of the waves. The cardboard sheets are subsequently transported by a further vacuum-belt 122 to the gluing station 144. The glue is applied from below at the gluing unit 126 and limited to the crests of the waves. Moreover, the glue is applied in the form of stripes along the transport direction of the sheets. This is to avoid contamination of the knives 136 at the position 146 of the following stack 128 onto which the arriving sheets are glued. Additionally, the stripe-wise application of the glue prevents subsequently cut stripes to fuse again to a continuous sheet.

At the position 146 of the stack 128 the cardboard sheets are glued to a cardboard block. This happens by pressing down the metal profiles 132, 134, which are arranged along the transport direction of the sheets arriving at position 146, i.e. in the direction perpendicular to the waves of the corrugated cardboard. There are knives attached to the metal profiles forming a cutting unit which can be moved in the longitudinal direction 138, whereby the knives cut every newly glued cardboard sheet perpendicular to the waves along its entire length. Depending on the height of the waves the cutting procedure can also be carried out more than once. The result is a stack of vertically standing cardboard plates (honeycombs) made from corrugated cardboard wherein the direction of the waves (openings of the honeycomb) is perpendicular to the plane of the plates. Preferably, three to five of the sheets at the bottom 130 and top 131 of the stack remain uncut. This conveys sufficient stability to the stack to enable its rotation by 90 degrees, whereby the cardboard plates (honeycombs) assume a horizontal position. As long as said bottom and top sheets remain uncut, the stack of cardboard plates can be easily transported without falling apart. Prior to further processing the glued but intact bottom and top sheets can be removed, for example by a chain saw, so that now the stack consists of separated cardboard plates (honeycombs).

The metal profiles 132, 134 can be arranged at unequal distances. This permits cardboard plates of different strength to be produced during the cutting process. For a width of the cardboard web delivered by the cardboard production machine above 2.00 m it may be advantageous to apply longitudinal cuts also through the bottom and top sheets although not at the distance defining individual cardboard plates (honeycombs) but rather at a desired distance of for example 1.20-1.30 m. This results in narrower blocks of cardboard plates which can be transported more easily. It may be advantageous to apply these widely spaced cuts already in the cardboard production machine or during the roll-off process, preferably by installed circular knives.

Knives 118 and 136 are preferably either razor blades or circular knives. Oscillating tangential knives may be used as well. These knives all produce minimal waste and dust. Corresponding tangential knives are offered, e.g., by the following companies: (1) Petra Haase Computer Technology in Neuss, (2) EM-System GmbH, Oberhausen, (3) Zünd Swiss Cutting Systems, Altstatten, (4) Elektronik & Sign GmbH, Schwarzenbek. Equipment for cutting with razor blades are delivered by (1) Dienes Werke GmbH, Overath, (2) Robust Habicht & Heuser GmbH, Remscheid (3) Kambach Industrial Representatives, Steinhagen, who represent a large number of Italian and German companies. An alternative way of cutting the corrugated cardboard may consist of the application of pressurized air.

In another embodiment cut cardboard sheets from a stack of cardboard sheets are further processed at the stations 142, 144 and 146. This has the advantage that also multiply corrugated cardboard may be used.

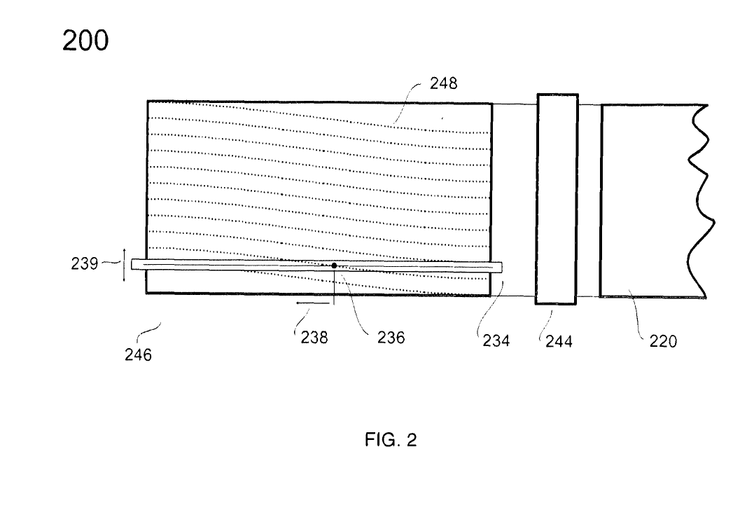

The plan-view 200 of FIG. 2 is an embodiment suitable for the fabrication of three-dimensional, for example curved honeycomb structures, for example honeycombs curved in various directions. A sheet of corrugated cardboard 220 is transported to the gluing station 244 where its entire surface is supplied with fast drying glue. In a first step each newly arriving sheet is pressed by metal profiles (not shown) onto the stack 246 of sheets below, which results in its immediate gluing to the stack. In the subsequent cutting process by a cutting unit consisting of a metal profile 234 with integrated tangential knife 236, moveable in the longitudinal direction 238 of the profile (which is also the direction of sheet transport), is translated transversely to the direction of transport 238. The simultaneous movement of the knife 236 in longitudinal direction 238 of the metal profile and the movement of the profile in the transverse direction 239 permits the application of a cut 248 of arbitrary shape. Upon cutting each arriving cardboard sheet in a similar way, honeycomb structures with constant cross-sectional profile 248 in the plane defined by the directions 238, 239. These honeycomb structures are therefore no longer planar plates but assume a three-dimensional shape.

The described apparatus for the two-dimensional movement of a single knife is exemplary only. The invention comprises also the use of several knives which may be attached in different ways. Finally, the cuts 248 through consecutive cardboard sheets may be slightly offset in the direction 239. In this way honeycombs may be produced exhibiting curvature in two directions which further enhances their three-dimensional character.

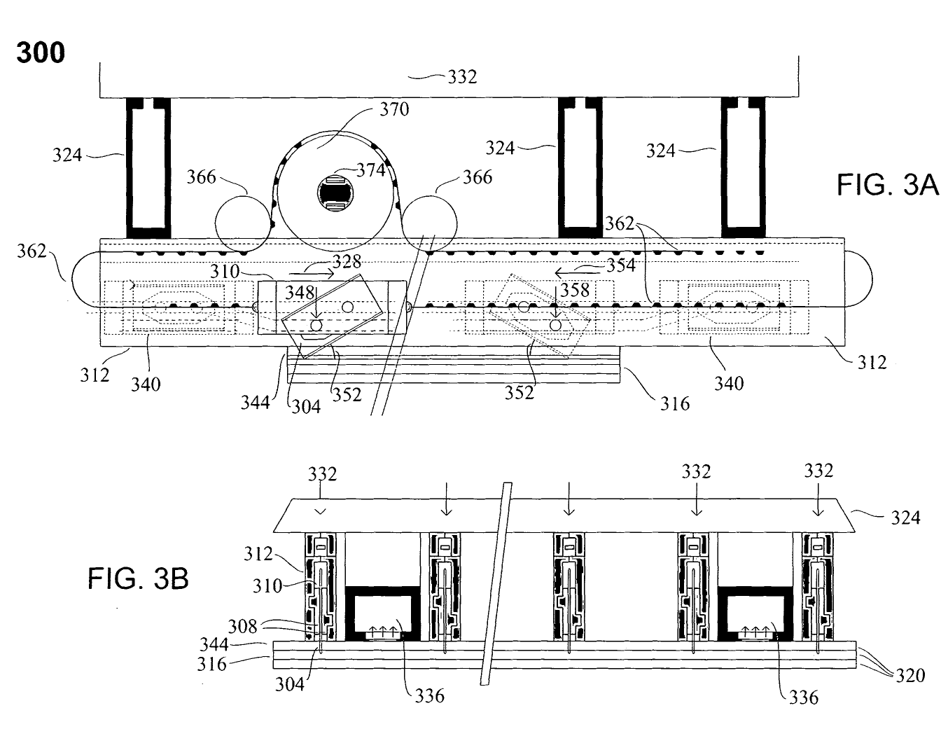

Embodiment 300 of a cutting apparatus comprising industrial razor blades is shown in FIG. 3A in side-view and in FIG. 3B in front view. The razor blades 304 are clamped in a double-shell chuck 308 which can be moved as sledges 310 along stationary cutting rails 312. Several of these cutting rails are mounted parallel to each other or under a defined angle. As a result, the stack 316 of cardboard sheets can be cut either into plates (honeycombs) of constant thickness or into honeycombs of wedge shape. In addition the cutting rails 312 serve the purpose of pressing the cardboard sheets 320, on the wave side of which glue has been applied, onto the stack 316. This can be realized for example by loaded beams 324 spanning across all cutting rails in the direction perpendicular to the cutting direction 328, 354. The force on the beams 324 is preferably applied in the form of a weight 332 evenly distributed over the entire block or stack 316 of cardboard sheets. Every time before lowering the rails 312 and pressing them onto the cardboard stack, a new cardboard sheet transversely cut from the cardboard web at the cutting station 142 and supplied with glue at the gluing station 144, is transported by a vacuum-belt 336 to a position exactly above the stack 316 at a distance of about 5-10 mm above its top. Then the newly arrived cardboard is pressed by the cutting rails onto the stack and cut within seconds by the knives.

In the following a preferred process 300 of cutting will be explained in greater detail. As long as the sledge 310 with the razor blades 304 is located outside the stack 316, the razor blades are preferably oriented in the horizontal direction 340 within the sledge, without protruding from the sledge. This is a measure to prevent any injuries. Shortly before the sledge 310, moving for example in direction 328 towards the right, reaches the topmost cardboard sheet 344 to be cut, the rear part 348 of the razor blade 304 is pushed down such that the cutting edge of the blade assumes an angle 352 of about 30° with respect to the surface of the sheet 344. Preferably the cutting depth is chosen to be about 1.5 times the thickness of the cardboard sheet 344. As soon as the razor blade reaches the end of the stack 316, it is again moved into a horizontal position for the reason explained above. After the subsequent raising of the cutting rails 312 a new cardboard sheet 344 supplied with glue is brought into position by the vacuum-belt 336 and pressed onto the stack. Now the sledge moves in the opposite direction 354 and the rear part 358 of the razor blade is again pushed to the cutting angle of 30° as soon as it is in position for cutting the new sheet. In this way each uppermost cardboard sheet 344 of the stack 316 is cut within 3-5 seconds by the knives oscillating back and forth.

The movement of the sledges 310 is preferably realized in the following way. Each sledge is fastened to a toothed belt 362 which is driven by means of a deflection pulley 366 and a gearwheel 370. The gearwheels 370 are arranged on a common shaft 374 and driven by a motor. In this way the sledges move synchronously back and forth as required by the principle of cutting apparatus 300.

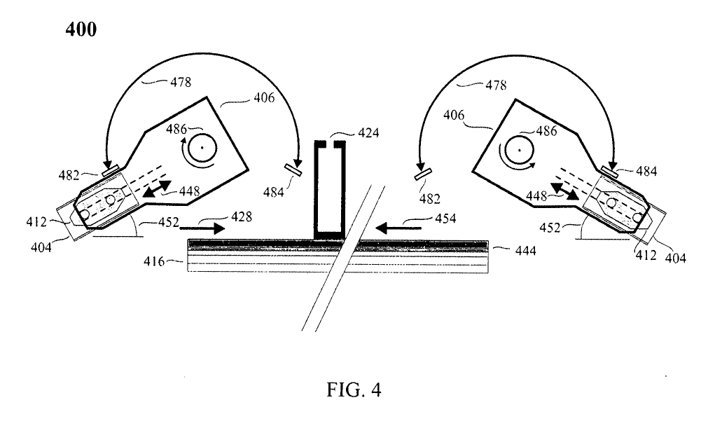

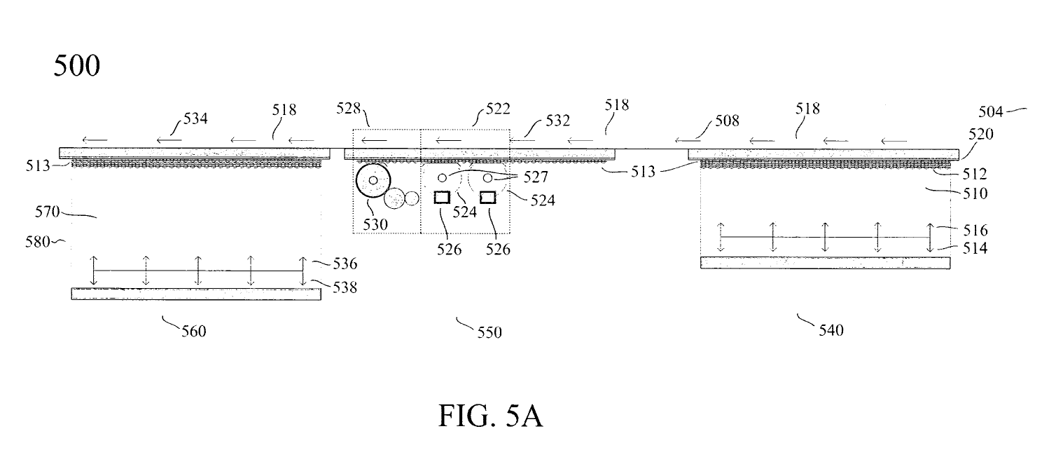

In the following an apparatus 400 for cutting cardboard sheets is described in greater detail as outlined in FIG. 4. This apparatus is suited for example for the use of pneumatically driven holders 406 for razor blades. The razor blades 404 are again fastened between two plates 412. As long as the razor blades are outside the stack 416 they can be moved in longitudinal direction 448 into the interior of holders 406 as a protection against injuries. The holders of the blades are preferably attached to a common shaft 486. They can all be moved simultaneously, e.g., by pneumatic action 478 between two fixed end stops 482, 484. When the suspension 486 of the blade holders is moved for example in the direction 428 to the right, the end stop 482 ensures that the blades 404 in their extended position move under an angle 452 of approximately 30° across the topmost cardboard sheet 444 of the cardboard stack 416, whereby sheet 444 is cut. Prior to positioning a new cardboard sheet 444 onto the stack 416 by vacuum-belt 336, the holders 406 with retracted razor blades 404 are rotated to the end stop 484. Upon pressing the sheet 444 by cross rails 424 onto the stack 416 the new cut with extended blades can be carried out in the direction 454 from right to left.

The horizontal movement of the blades across the stack 416 is preferably realized by connecting the suspensions 486 of blade holders 406 rigidly to an oscillating toothed belt 362 or to several synchronously oscillating toothed belts 362. The oscillatory motion of the toothed belt or the toothed belts is driven by a single motor. By nature of the embodiment with blade holders 406 suspended by a common shaft 486, the resulting cardboard plates (honeycombs) all have the same thickness. More complicated suspensions may permit fabrication of wedge-like honeycombs also in this case.

In another embodiment circular knives are used instead of the razor blades 304, 404. This simplifies the cutting apparatus since the holders of the knives no longer need to be tilted to the new cutting angle 352, 452.

All embodiments described so far have in common that the sledges 310 or the holders 308, 406 can individually be removed from their suspensions to allow cleaning or replacement of the blades 304, 404.

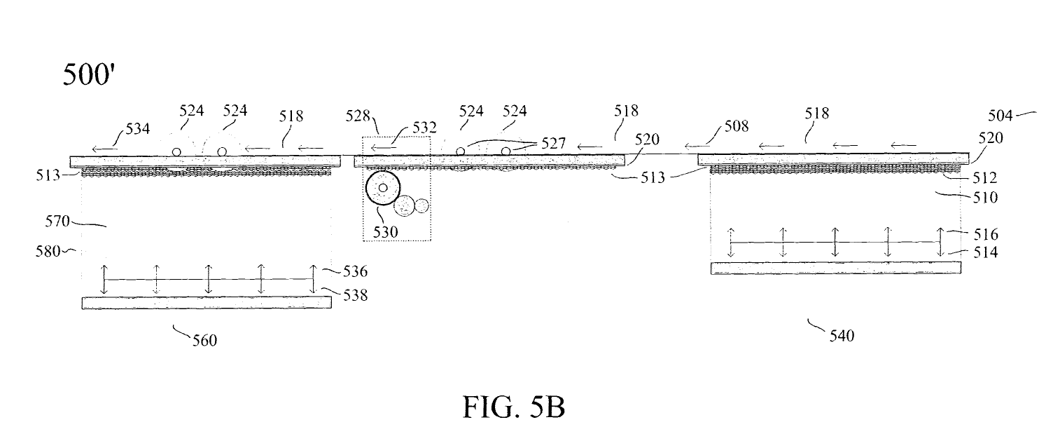

A preferred embodiment 500 of a cutting apparatus with circular, disk-like knives is now described by reference to the side view of FIG. 5A. By contrast to all previous embodiments, embodiment 500 is characterized by knives the position of which remains stationary during the cutting process while the cardboard sheets move themselves. A web of singly or multiply corrugated cardboard with the open wave directed towards the bottom as defined in FIG. 5A is transported cyclically by a vacuum-belt either directly from a cardboard production machine or from a roll-off device 504 to a station (not shown) at which it is cut perpendicular to the transport direction of the web, i.e. parallel to the crests of the waves into sheets 512. The sheets 512 are either stored in the form of a stack of sheets or immediately processed further. In the following the further processing starting from a stack of sheets located at station 540 will be discussed in detail. The stack of sheets 510 can be moved in upward direction 516 or downward direction 514 at the station 540. Upward and downward directions 516, 514 are defined in FIG. 5A. Before the carriage 518 with plate 520, into which a vacuum generating device for attracting the topmost cardboard sheet 513 is integrated, is moved into position above the stack, the stack is lowered by a few millimeters. By this action touching of the topmost cardboard sheet 513 of the stack can be avoided during the motion of carriage 518. As soon as the carriage is positioned accurately above the stack 510 to allow the topmost sheet to be picked up, the stack 510 moves in the upward direction 516 until it presses slightly towards the plate 520. Simultaneously, the topmost cardboard sheet 513 is sucked towards the plate 520 and firmly fixed by the vacuum generating device integrated in the plate. The stack 510 is now moved down in the direction 514 until a gap of a few millimeters has opened up between the cardboard sheet immediately located beneath the one attracted by the plate.

The carriage 518 with the cardboard plate 513 firmly attracted by the plate 520 now moves in the direction 508 to the station 550 comprising a cutting station 522 and a gluing station 528 with gluing unit 530. In another aspect of the embodiment the order of cutting and gluing stations are interchanged. Several circular, disk-like knives 524 are mounted on at least one shaft 527 at the cutting station 522. The knives 524 at the cutting station 522 remain stationary (i.e., do not move laterally), while the plate 520 with firmly attached cardboard sheet 513 is moved across, whereby the sheet is cut into (longitudinal) stripes parallel to the direction of motion 532 of the carriage 518. In the presence of more than one shaft 527 equipped with circular knives 524, the sheets 513 can be cut into thin stripes. In a preferred aspect of the embodiment the knives are continuously sharpened by the grinding tools 526 arranged below or on the side of the knives. In order to assure a constant depth of the cuts despite abrasion of the knives during their sharpening, the shrinking diameter of the knives caused by their sharpening may be continuously monitored by sensors. A feedback mechanism may then adjust the distance of the shafts 527 to the plate 520, thereby guaranteeing said constant depth of cut. The cardboard sheet 513 cut into longitudinal stripes, remaining firmly attached to the plate 520 by vacuum action, passes the gluing station 528. At the gluing station 528 the cardboard stripes are supplied with glue by the gluing unit 530 from below onto the crests of the waves. The glue is applied only along the central region of the stripes in order to make sure that the stripes remain unconnected by glue at the station 560 of the assembled honeycomb stack.

The assembly of the stack of cardboard plates (honeycombs) at station 560 evolves as follows. The cardboard stack 570 already glued into a block of cardboard plates 580 is moved in the downward direction 538 by a few millimeters. The carriage 518 with the cardboard stripes supplied with glue attracted by the plate 520 is moved in the direction 534 above the block of cardboard plates 580 without touching the latter. The movement is carried out with submillimeter precision, such that the new cardboard sheet is positioned precisely above the cardboard stack 570. The block 580 is now moved in the upward direction 536 such that its topmost cardboard sheet is pressed against the cut cardboard sheet 513 supplied with glue attracted to plate 520. Carriage 518 and cardboard block 580 remain in this position for a short time until the sheet 513 is firmly attached to the cardboard stack 570 or cardboard block 580, respectively. The vacuum in the plate 520 is now interrupted and the cardboard block 580 is again lowered by a few millimeters in the downward direction 538 such that a gap arises between the plate 520 and the cardboard stack 570 whereby the carriage 518 can be moved again to its initial position at the station 540. The process is repeated at station 540 by attracting a new sheet 513 to plate 520 by vacuum.

In the related embodiment 550′ of FIG. 5B the circular, disk-like knives are not mounted to a stationary cutting station 522 but rather integrated into the carriage 518 somewhat similar to embodiments 100-400 with razor blades. In accordance with those embodiments cardboard sheets 513 coming from stacks 510 are supplied with fast drying glue at gluing station 528 in a stripe-wise fashion in order to avoid contamination of the circular knives in the subsequent cutting process of cardboard stack 570. In this embodiment each cardboard sheet 513 is positioned with sub-millimeter precision above the already cut stack 570 by translating the carriage 518. Prior to moving the carriage into this position, the stack is moved in downward direction 538 by a few millimeters in order to avoid collision with the newly transported sheet 513 while it is brought into position above the stack. As soon as the new sheet 513 is in place above the stack 570, the stack is moved in upward direction 536 and pressed against the sheet 513 for a short time until the glue is sufficiently cured. After breaking the vacuum generated in the plate 520 the stack 570 is lowered in the downward direction 538 by a few millimeters, such that the carriage 518 is again free to move. The carriage 518 with integrated circular knives 524 is moved once in the direction 534 across the entire stack 570 and then back to station 540 at which a new sheet 513 is attracted by the plate 520. During the back and forth movement of carriage 518 across the cardboard stack 570 at least the topmost cardboard sheet 513 is cut entirely through. In analogy to the embodiments 100-400 the result is a block of cardboard plates (honeycombs) 580 consisting of stripes of cardboard glued on top of each other, where the waves (pores of the honeycomb) are directed perpendicular to the plane of the plates

It should be appreciated that the particular implementations shown and herein described are representative of the invention and its best mode and are not intended to limit the scope of the present invention in any way.

As will be appreciated by skilled artisans, the present invention may be embodied as a system, a device, or a method.

It is an advantage of the invention that it permits mechanically stable rectangular and quadratic plates (honeycombs) to be fabricated directly from a cardboard production machine or a roll-off device.

It is a further advantage of the invention that the cardboard plates (honeycombs) can be fabricated with minimal waste and minimal dust generation.

A further advantage of the invention lies in the possibility to fabricate non-planar, i.e., three-dimensional cardboard structures (honeycombs).

A further advantage of the invention is the ability to process singly or multiply corrugated cardboard sheets from stacks of cardboard sheets to rectangular or quadratic stacks of plates (honeycombs).

Benefits, other advantages and solutions mentioned herein are not to be construed as critical, required or essential features or components of any or all the claims.

The present invention is described herein with reference to block diagrams, devices, components, and modules, according to various aspects of the invention. It will be understood that each functional block of the blocks diagrams, and combinations of functional blocks in the block diagrams, can be implemented in part by computer program instructions which may be loaded onto a general purpose computer, special purpose computer, or other programmable data processing apparatus to produce a machine, such that the instructions which execute on the computer or other programmable data processing apparatus create enable the functionality specified in the block diagrams.

Accordingly, the block diagram illustrations support combinations of means for performing the specified functions, combinations of steps for performing the specified functions, and program instruction means for performing the specified functions. Each functional block of the block diagrams and flowchart illustrations, and combinations of functional blocks in the block diagrams, may be implemented by either special purpose hardware-based computer systems which perform the specified functions or steps, or suitable combinations thereof.

Moreover, the system contemplates the use, sale and/or distribution of any goods, services or information having similar functionality described herein.

As used herein, the terms “comprises”, “comprising”, or variations thereof, are intended to refer to a non-exclusive listing of elements, such that any apparatus, process, method, article, or composition of the invention that comprises a list of elements, that does not include only those elements recited, but may also include other elements described in the instant specification. Unless otherwise explicitly stated, the use of the term “consisting” or “consisting of” or “consisting essentially of” is not intended to limit the scope of the invention to the enumerated elements named thereafter, unless otherwise indicated. Other combinations and/or modifications of the above-described elements, materials or structures used in the practice of the present invention may be varied or adapted by the skilled artisan to other designs without departing from the general principles of the invention.

The patents and articles mentioned above are hereby incorporated by reference herein, unless otherwise noted, to the extent that the same are not inconsistent with this disclosure.

Other characteristics and modes of execution of the invention are described in the appended claims.

Further, the invention should be considered as comprising all possible combinations of every feature described in the instant specification, appended claims, and/or drawing figures which may be considered new, inventive and industrially applicable.

Copyright may be owned by the Applicant(s) or their assignee and, with respect to express Licensees to third parties of the rights defined in one or more claims herein, no implied license is granted herein to use the invention as defined in the remaining claims. Further, vis-à-vis the public or third parties, no express or implied license is granted to prepare derivative works based on this patent specification, inclusive of the appendix hereto and any computer program comprised therein.

Additional features and functionality of the invention are described in the claims appended hereto. Such claims are hereby incorporated in their entirety by reference thereto in this specification and should be considered as part of the application as filed.

Multiple variations and modifications are possible in the embodiments of the invention described here. Although certain illustrative embodiments of the invention have been shown and described here, a wide range of changes, modifications, and substitutions is contemplated in the foregoing disclosure. While the above description contains many specific details, these should not be construed as limitations on the scope of the invention, but rather exemplify one or another preferred embodiment thereof. In some instances, some features of the present invention may be employed without a corresponding use of the other features. Accordingly, it is appropriate that the foregoing description be construed broadly and understood as being illustrative only, the spirit and scope of the invention being limited only by the claims which ultimately issue in this application.

Addendum

The following US and other patent documents form an integral part of this application

US patent documents

Other patent documents

| | | | |
|---|---|---|---|
| WO9316927 | A1 | September 1993 | Iseli |
| DE196 54 672 | A1 | February 1998 | Iseli |
| DE103 05 747 | A1 | August 2004 | Iseli |

| | | |
|---|---|---|
| PCT/IB2012/002173 | October 2012 | Iseli |

1. Apparatus for the fabrication of ultralight stable structures from corrugated cardboard, wherein the apparatus comprises:
a. a transporter adapted to transport a web of corrugated cardboard to a first cutting station;
b. the said first cutting station, adapted to cut said web of corrugated cardboard into cardboard sheets in a direction parallel to the crest of the waves;
c. a stacker adapted to stack said corrugated cardboard sheets into corrugated cardboard stacks;
d. a conveyer, adapted to attract the corrugated cardboard sheets one at a time and to transport them from said corrugated cardboard stack to a gluing station;
e. a gluing station adapted to apply glue to the exposed crests of said waves;
f. a second cutting station adapted to cut said corrugated cardboard sheets along a cutting plane, into stripes along the direction of transport;
g. a positioning device adapted to position the corrugated cardboard sheets supplied with glue at a further station, and
h. a pressing station adapted to press a corrugated cardboard sheet to a stack of corrugated cardboard sheets, whereby cut plates from corrugated cardboard are formed in which the direction of the waves is perpendicular to the cutting plane.

2. The apparatus of claim 1, wherein the transporter includes one or more vacuum-belts attracting its substrate foil either directly from a cardboard production machine or from a roll-off device.

3. The apparatus of claim 1, wherein the conveyer conveys by a vacuum of a vacuum-belt or a vacuum plate.

4. The apparatus of claim 1, wherein, at least one cutting unit is equipped with knives to cut the corrugated cardboard sheets into strips.

5. Apparatus of claim 4, wherein said gluing station permits application of glue in the form of stripes whereby contamination of the knives is avoided.

6. Apparatus of claim 1, wherein at least one cutting unit remains stationary during the cutting of said corrugated cardboard sheets into said stripes.

7. Apparatus of claim 1, wherein at least one cutting unit moves across said corrugated cardboard sheets during their cutting into said stripes.

8. Apparatus of claim 1, wherein at least one cutting unit cuts said corrugated cardboard sheets using at least one sharp, narrow blade in order to minimize material loss and dust generation, the cutting being performed within 3-5 sec; and being carried out at a cutting depth of about 1.5 times the thickness of said corrugated cardboard sheets.

9. Apparatus of claim 1, wherein said cutting unit is equipped with knives selected from at least one of a group of knives consisting of:
a. industrial razor blades;
b. circular, disk-like knives; and
c. oscillating tangential knives.

10. Apparatus of claim 1, wherein at least one cutting unit comprises circular, disk-like knives which are continuously sharpened by grinding tools.

11. Apparatus of claim 1, wherein at least one cutting unit cuts at a depth kept constant by a feedback mechanism correcting for the shrinking diameter of said circular, disk-like knives caused by their sharpening.

12. Apparatus of claim 1, wherein in said cutting unit, at least one knife is
a. oriented parallel to said direction of transport or perpendicular to the crests of said waves, whereby said plates from corrugated cardboard (honeycombs) are planar and all have constant thicknesses;
b. oriented at an angle to each other, whereby said plates from corrugated cardboard (honeycombs) are wedge-shaped; or
c. oriented in more than one direction, whereby said honeycombs may assume a three-dimensional curved shape.

13. Apparatus of claim 1, wherein at least one cutting unit has knives adapted to be individually removed from their holders to permit cleaning or replacement.

14. A method for producing ultralight stable structures from corrugated cardboard, the method comprising the steps of:
a. transporting a web of corrugated cardboard to a first cutting station;
b. at said first cutting station, cutting said web of corrugated cardboard into cardboard sheets in a direction parallel to the crest of the waves;
c. stacking said corrugated cardboard sheets to corrugated cardboard stacks;
d. attracting the corrugated cardboard sheets one at a time and transporting from said corrugated cardboard stack to a gluing station;
e. applying glue to the exposed crests of said waves;
f. cutting of said corrugated cardboard sheets along a cutting plane, into stripes along the direction of transport; and
g. positioning the corrugated cardboard sheets supplied with glue at a further station and pressing to a stack of corrugated cardboard sheets, whereby cut plates from corrugated cardboard are formed (honeycombs) in which the direction of the waves is perpendicular to the cutting plane.

15. The method of claim 14, wherein the transporting is effected essentially by one or more vacuum-belts attracting its substrate foil either directly from a cardboard production machine or from a roll-off device.

16. The method of claim 14, wherein, in step d, the attracting is effected by a vacuum of a vacuum-belt or a vacuum plate.

17. The method of claim 14, wherein a cutting unit equipped with knives cuts the corrugated cardboard sheets into strips.

18. The method of claim 14, wherein at least one said gluing station permits application of glue in the form of stripes whereby contamination of any cutting knives is avoided.

19. The method of claim 17, wherein at least one cutting unit remains stationary during the cutting of said corrugated cardboard sheets into said stripes.

20. The method of claim 17, wherein the cutting unit moves across said corrugated cardboard sheets during their cutting into said stripes.

21. The method of claim 17, wherein at least one cutting unit cuts said corrugated cardboard sheets using at least one sharp, narrow blade in order to minimize material loss and dust generation, the cutting being performed within 3-5 sec; and being carried out at a cutting depth of about 1.5 times the thickness of said corrugated cardboard sheets.

22. The method of claim 17, wherein at least one said cutting unit is equipped with knives selected from at least one of a group of knives consisting of:
a. industrial razor blades;
b. circular, disk-like knives; and
c. oscillating tangential knives.

23. The method of claim 17, wherein knives of the cutting unit include circular, disk-like knives which are continuously sharpened by grinding tools during operation.

24. The method of claim 17, wherein the cutting depth is kept constant by a feedback mechanism correcting for the shrinking diameter of said circular, disk-like knives caused by their sharpening.
